(19) United States
(12) Patent Application Publication
(10) Pub. No.: US 2001/0015878 A1
(43) Pub. Date: Aug. 23, 2001

(54) Magnetic sensor and magnetic storage using same

(75) Inventors: Lajos Varga, Budapest (HU); Yutaka Shimizu, Kawasaki (JP); Shin Eguchi, Kawasaki (JP); Atsushi Tanaka, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 09/758,701

(22) Filed: Jan. 11, 2001

(30) Foreign Application Priority Data
Feb. 3, 2000 (JP) 2000-026752

(51) Int. Cl. G11B 5/39

(52) U.S. Cl. 360/324.12

(57) ABSTRACT

A magnetic sensor which includes a laminate comprising a first magnetic layer of soft ferromagnetic material, a nonmagnetic layer, a second magnetic layer of ferromagnetic material, and an antiferromagnetic layer, and a converting element for detecting the change in external magnetic field as the change in resistance and outputing it, with at least part of the first magnetic layer being formed of an Ni—Fe material, and the content of Ni, x_{Ni}, in wt % and the thickness, t, in nanometer thereof satisfying the relation represented by the following equation:

$${x}_{N1} ≧ - \frac{{B}_{1}^{Surf} + {B}_{1}^{Bulk} \cdot t}{{B}_{2}^{Surf} + {B}_{2}^{Bulk} \cdot t}$$

wherein B^{Bulk}₁=−53.78 J/cm³, B^{Bulk}₂=0.6638 J/cm³, B^{Surf}₁=1.7548×10⁻⁶ J/cm², and B^{Surf}₂=−2.432×10⁻⁸ J/cm². A magnetic storage comprising a magnetic head and a magnetic recording medium, wherein the magnetic head uses the magnetic sensor according to the invention, is also disclosed.

### CROSS-REFERENCE TO RELATED APPLICATION

This application is based upon and claims priority of Japanese Patent Application No. 2000-26752, filed on Feb. 3, 2000, the contents being incorporated herein by reference.

### BACKGROUND OF THE INVENTION

1. Field of the Invention

The invention relates to a magnetic sensor and, specifically, to a magnetic sensor which senses a externally applied magnetic field by a change in resistance due to the magnetic field. In particular, the invention relates to a magnetic sensor which uses a very thin (<10 nanometers) Ni—Fe film to sense a magnetic field, such as a spin valve magnetoresistive sensor. The invention also relates to a magnetic storage using such a magnetic sensor.

2. Description of the Related Art

A magnetic sensor is indispensable in a variety of fields. By way of example, magnetic sensors are used in the magnetic heads of magnetic storages for various computers.

A typical magnetic storage for a computer is a hard disk device and uses, as a recording medium, a hard disk having a thin film of a magnetic material for recording provided on a hard substrate, such as an aluminum substrate, and rotated by a driving means (disk drive), and writes information to and reads information from the recording medium using a head attached to an end of a head-moving mechanism called a slider. The storage capacities of hard disks are increasing year by year, and heads for the hard disk devices must cope with this trend.

As a read head for a hard disk having a high data density, an MR head which uses magnetoresistive (MR) effect, and senses the change in external magnetic field as a change in resistance and outputs it as a change in voltage, in place of a conventional head of an induction type utilizing the principle of electric induction. The MR head uses a single-layer film (normally an Ni—Fe film) displaying anisotropic magnetoresistive effect to sense an external magnetic field.

More recently, a GMR head has been used in practice, the GMR head using giant magnetoresistive (GMR) effect and having a higher sensitivity than that of a conventional MR head and, accordingly, showing a larger change in resistance when the same external magnetic field is applied, to thereby make it possible to provide a large output. The giant magnetoresistive effect developed in the GMR head stems from a multi-layer film. Several types of films having a multi-layer construction showing a giant magnetoresistive effect are known. Among these, a film having a simple construction of layers and having a relatively large rate of change in resistance even under a weak magnetic field is one known as a spin valve (SV) film, which is used in most practical GMR heads.

In principle, a spin valve film has a laminated structure in which at least four layers, a first magnetic layer, which has a variable direction of magnetization and is called a free magnetic layer (also simply called a free layer), a nonmagnetic layer, a second magnetic layer, which has a fixed direction of magnetization and is called a fixed magnetic layer (also simply called a fixed layer, or a pinned layer), and an antiferromagnetic layer for fixing the direction of magnetization of the second magnetic layer (fixed magnetic layer) by exchange coupling thereto, are sequentially laminated. When an external magnetic field is applied to the spin valve film of such a laminated structure, the direction of magnetization of the fixed magnetic layer is fixed and unchanged, whereas the direction of magnetization of the free magnetic layer is changed depending on the direction of the external magnetic field, and, accordingly, the electrical resistively of the spin valve film is changed due to the change in relative orientation of the magnetizations of the two layers. The resistivity of the spin valve film is minimal when the directions of magnetization of the fixed magnetic layer and the free magnetic layer are the same (the difference between their directions of magnetization is zero degree), and maximal when the directions of magnetization of the two layers are opposite (the difference between their directions of magnetization is 180 degrees). Thus, since the electrical resistively of the spin valve film is determined by the relative orientation of the magnetizations of the free magnetic layer and the fixed magnetic layer, the spin valve film can provide a very sensitive magnetic sensor.

Such a spin valve film used in a head includes two magnetic layers separated from each other by a thin nonmagnetic intermediate layer, and an antiferromagnetic layer for fixing the direction of magnetization of one magnetic layer, as described above. A magnetic head which is fabricated using this spin valve film has, in general, a substrate on which various layers for the magnetic sensor are formed, an underlying layer (also called buffer layer) initially formed on the substrate, the spin valve film consisting of the first magnetic layer (free magnetic layer) of a soft ferromagnetic material, the nonmagnetic layer, the second magnetic layer (fixed magnetic layer) of a ferromagnetic material, and the antiferromagnetic layer which are successively formed on the underlying layer, and a protective film (anti-oxidizing film) provided on the spin valve film. The magnetic head having the structure in which the antiferromagnetic layer is remote from the substrate, with the two magnetic layers being interposed therebetween, as described above, is referred to as a top-type magnetic head. In contrast, the magnetic head of a structure in which the antiferromagnetic layer is closer to the substrate, and is located between the substrate and the two magnetic layers, is referred to as a bottom-type magnetic head.

For the substrate, a material such as alumina-TiC (often called AlTiC) is used, in general. The underlying layer, which is formed of, in general, tantalum (Ta), serves to orient the first magnetic layer to a predetermined orientation plane during the formation of the first magnetic layer, and prevents diffusion of material from the substrate. The nonmagnetic layer between the two magnetic layers is formed of copper (Cu), in general.

In most cases, the soft ferromagnetic film for free magnetic layer used in the spin valve film is formed of a material containing 81 wt % Ni and 19 wt % Fe, or is made up of a layer of an alloy having that composition and another layer of a different ferromagnetic alloy. The free magnetic layer used in the spin valve film typically has a thickness of less than 10 nanometers. The composition of 81 wt % Ni and 19 wt % is selected for such a layer for the reason that it gives excellent soft magnetic properties, i.e., high permeability, low anisotropy, low coercivity, and almost zero magnetostriction.

A read head, adapted to a magnetic storage such as a hard disk device having an increased memory density, has a sensor section, for sensing a magnetic field, which has a very small size. This indicates that making the laminated structure used in such a read head thinner is required and that, eventually, making the respective layers constituting the laminated structure thinner is required.

In the magnetic head thus made thinner, as the layers have a thickness of much less than 10 nanometers, the surface and stress effects are become more and more important. It is well known that in thin films of nickel or nickel alloys, the initial layers are nonmagnetic, and the magnetoelastic properties are also largely dependent on layer thicknesses. A thick film of Ni₈₁Fe₁₉ material has a magnetostriction close to zero and, accordingly, this material is commonly used in the conventional magnetic sensors using the magnetoresistive effect. However, the magnetostriction of this magnetic material becomes large and positive as the film thickness thereof approaches few nanometers which will be the film thickness of the free magnetic layer in the next generation read heads. In a read sensor, it is preferred that the magnetostriction of the free magnetic layer is ideally zero, and has a negative value rather than a positive value. A large positive magnetostriction of the free magnetic layer in the magnetic sensor of laminated structure made up of layers having a particularly small thickness for high memory density, which is used in a read head, is not desirable, and must be avoided.

### SUMMARY OF THE INVENTION

It is an object of the invention to resolve the problems. Specifically, the invention aims to provide a magnetic sensor with a free magnetic layer having a magnetostriction equal to or less than zero, and a magnetic storage, particularly with a high data density, having a highly sensitive magnetic head using the sensor.

According to the invention, as a free magnetic layer in a magnetic sensor, an Ni—Fe film is used, the Ni—Fe film having a content of Ni in wt %, x_{N1}, and a thickness t in nanometer which are selected so as to satisfy the relation represented by the following equation:

$${x}_{N1} ≧ - \frac{{B}_{1}^{Surf} + {B}_{1}^{Bulk} \cdot t}{{B}_{2}^{Surf} + {B}_{2}^{Bulk} \cdot t}$$

In the above equation,

$${B}_{1}^{Bulk} = - 53.78 J / {cm}^{3} , \\ {B}_{2}^{Bulk} = 0.6638 J / {cm}^{3} , \\ {B}_{1}^{Surf} = 1.7548 \times {10}^{- 6} J / {cm}^{2} , and$$

$${B}_{2}^{Surf} = - 2.432 \times {10}^{- 8} J / {cm}^{2} .$$

Thus, the invention provides a magnetic sensor which includes a laminate comprising a first magnetic layer (a free magnetic layer) of soft ferromagnetic material, a nonmagnetic layer, a second magnetic layer (a fixed magnetic layer) of ferromagnetic material, and an antiferromagnetic layer, and a converting element for detecting the change in external magnetic field as the change in resistance and outputing it, with at least part of the first magnetic layer being formed of an Ni—Fe material, and the content of Ni, x_{N1}, in wt % and the thickness, t, in nanometer thereof satisfying the relation represented by the above equation.

The invention also provides a magnetic storage comprising a magnetic head and a magnetic recording medium, wherein the magnetic head uses the magnetic sensor according to the invention.

### BRIEF DESCRIPTION OF THE DRAWINGS

The above and other objects and advantages of the invention will be well understood and appreciated, by a person with ordinary skill in the art, from consideration of the following detailed description made by referring to the attached drawings, wherein:

FIG. 1 illustrates a construction of layers in the magnetic sensor of the invention;

FIG. 2 is a graph showing the dependence of saturation magnetization, of various Ni—Fe films, on film thickness;

FIG. 3 is a graph showing thicknesses of dead layers, of Ni—Fe films, of various compositions;

FIG. 4 is a graph showing saturation magnetizations of Ni—Fe films, of various compositions, as a function of magnetization thickness;

FIG. 5 is a graph showing saturation magnetization as a function of the composition of the Ni—Fe film;

FIG. 6 is a graph showing magnetostriction as a function of the magnetic thickness of the Ni—Fe film;

FIG. 7 is a graph showing magnetostriction as a function of the composition of the Ni—Fe film;

FIG. 8 is a graph showing effective magnetoelastic coupling constant as a function of film thickness;

FIG. 9 is a graph showing the bulk magnetoelastic coupling constant and the surface magnetoelastic coupling constant as a function of composition;

FIG. 10 is a graph showing a composition at which magnetostriction of Ni—Fe film is zero, as a function of magnetic thickness;

FIG. 11 illustrates a magnetic sensor of the invention;

FIG. 12 is a perspective view illustrating a magnetic head in the invention; and

FIG. 13 is a perspective view illustrating a magnetic storage of the invention.

### DETAILED DESCRIPTION OF THE INVENTION

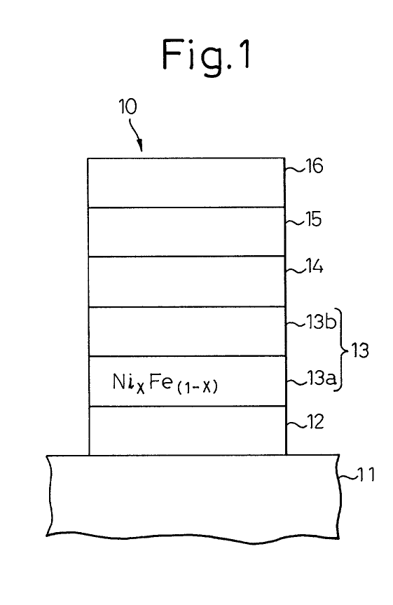

FIG. 1 illustrates the construction of the layers in the magnetic sensor of the invention. A laminate 10 constituting the magnetic sensor of the invention is made up of an underlying layer 12, a free magnetic layer 13, a nonmagnetic layer 14, a fixed magnetic layer 15, and an antiferromagnetic layer 16, which are successively formed on a substrate 11. For the substrate 11, a material such as AlTiC is generally used. The underlying layer 12, which is an optional layer in the laminate 10, is generally formed as a thin film of a material, such as tantalum (Ta), when used, and has a thickness of about 1 to 10 nanometers. The free magnetic layer 13 is formed of an Ni—Fe alloy of soft magnetic material. The layer 13 may be formed of a sublayer 13a of Ni—Fe alloy and a sublayer 13b of another magnetic material, as illustrated in the drawing. On the free magnetic layer 13, the nonmagnetic intermediate layer (or simply nonmagnetic layer) 14, which is formed of a nonmagnetic material such as copper (Cu), is located. The fixed magnetic layer 15 is formed on the layer 14 so as to be opposite to the free magnetic layer 13, with the layer 14 being interposed between the layers 13 and 15. A magnetic material for the fixed magnetic layer 15 is, in general, cobalt (Co), or a cobalt-based magnetic material, such as a Co—Fe alloy. On the fixed magnetic layer 15, the antiferromagnetic layer 16 exists, the layer 16 being formed of an antiferromagnetic alloy material such as Pt—Mn, Ni—Mn, or Fe—Mn, or an antiferromagnetic oxide material such as NiO or Fe₂O₃. In general, each of these layers is formed by the use of a physical vapor deposition (PVD) process. A protective layer may be provided on the antiferromagnetic layer 16, although it is not shown in FIG. 1. The protective layer would be formed of Ta, in general.

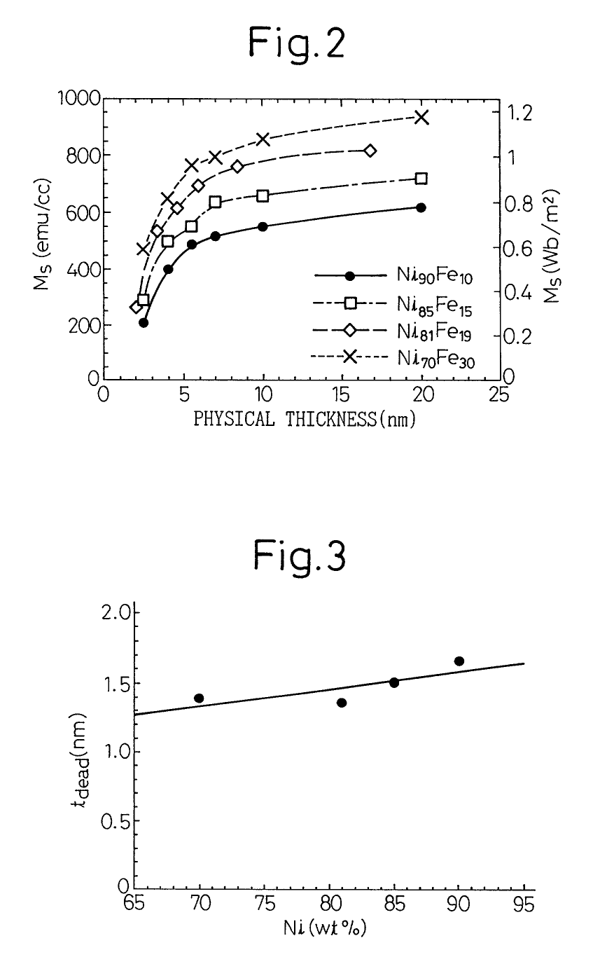

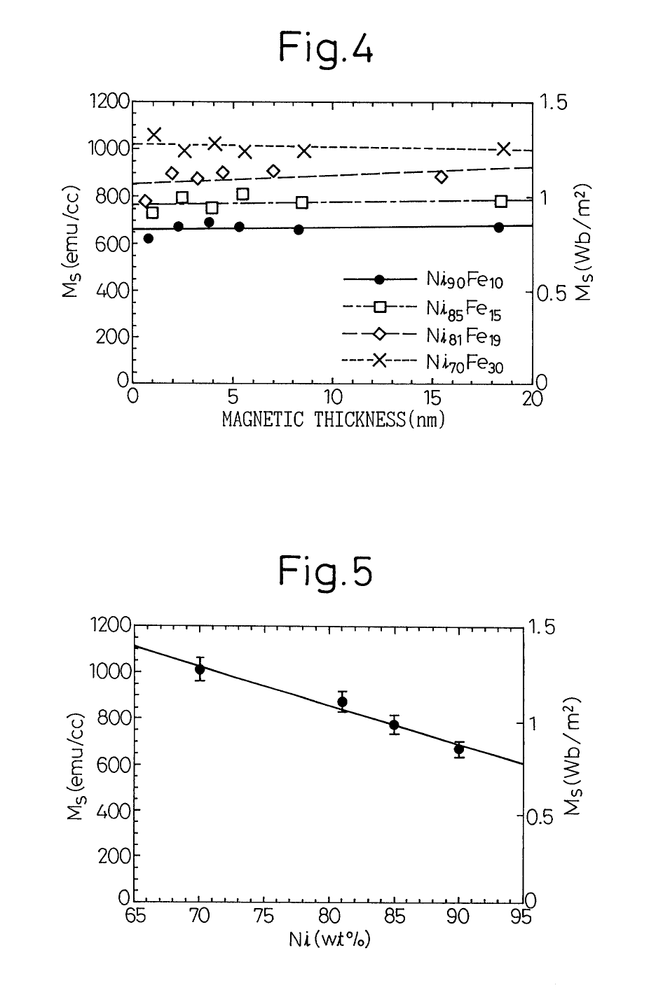

With respect to the soft magnetic layer of Ni—Fe, the inventors performed an experiment in which various Ni—Fe films were deposited with different Ni to Fe ratios using a sputtering system in order to investigate the dependency of magnetostriction on film thickness for different Ni—Fe compositions. The films were grown on a Ta underlying layer having a thickness of 5 nanometers formed on a glass substrate having a thickness of 150 micrometers, with film thicknesses ranging form 2.5 to 20 nanometers, and were then capped with a Ta layer having a thickness of 5 nanometers to prevent the oxidation of the grown Ni—Fe film. The saturation magnetization Mₛ of each of Ni—Fe films was measured using a vibrating sampling magnetization meter (VSM), and the results shown in FIG. 2 were obtained. Subsequently, from a plot of magnetic moment vs. film thickness, the thicknesses of the dead layers, t_{dead}, were determined for the films of different compositions, and were plotted against the Ni contents, as shown in FIG. 3. The saturation magnetization Mₛ, was then corrected for the dead layer by calculating the effective (magnetic) thickness of each Ni—Fe film, as shown in FIG. 4, and its value as a function of Ni content was in agreement with data of bulk Ni—Fe material, as shown in FIG. 5. The saturation magnetization Mₛ of the ordinate in FIGS. 2, 4, and 5, which is expressed in emu/cc unit, is converted to a corresponding value in Wb/m² SI units by being multiplied by 4π×10⁻⁴.

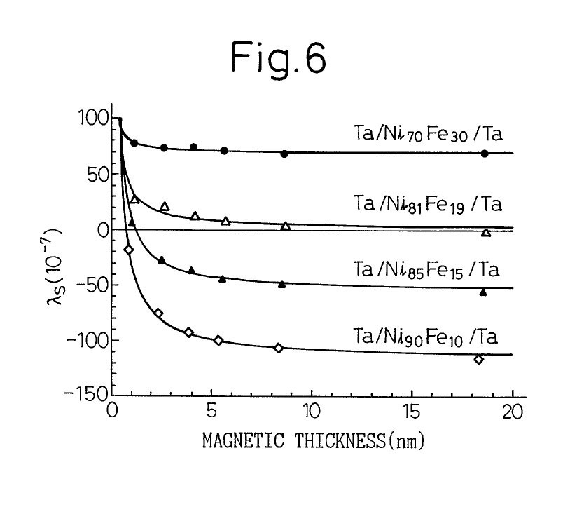

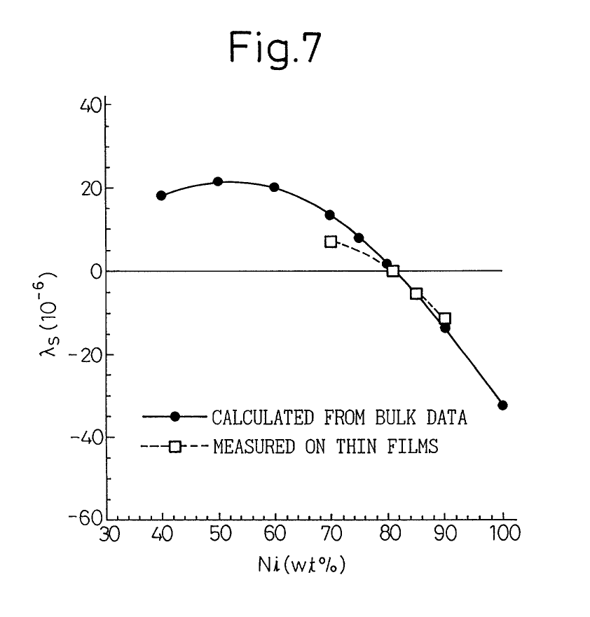

The magnetostriction constant λₛ of each Ni—Fe film was measured using the bending beam method in a commercial magnetostriction tester manufactured by Lafouda Co.. The dependence of Ni—Fe film magnetostriction on the thickness shows similar behavior for the investigated compositions, as shown in FIG. 6 in which the magnetostriction constant λₛ is plotted versus the magnetic thickness, and the values for thick films well agree with the data of bulk material, as shown in FIG. 7.

In order to understand the dependence of magnetostriction on the film thickness, the effective magnetoelastic coupling constants B_{eff} were calculated, according to the following equation, from the measured data of magnetostriction using the elastic constants of polycrystalline Ni—Fe:

$${B}_{eff} = - 3 {λ}_{s}^{measured} = \frac{{E}_{f}}{1 + {v}_{f}} \qquad ( 1 )$$

In the above equation, λ^{measured}ₛ is measured data of the magnetostriction, E_{f} is Young's modulus for Ni—Fe, and v_{f} is Poisson's ratio for Ni—Fe.

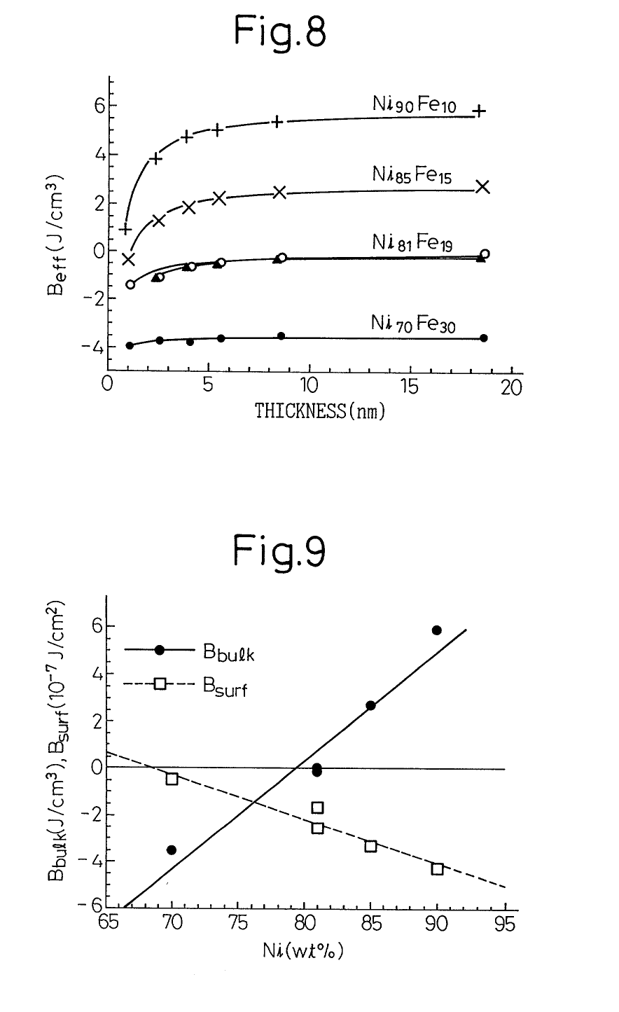

The effective magnetoelastic coupling constants thus calculated were then fitted to Neel's surface anisotropy model, to obtain the results shown in FIG. 8. The effective magnetoelastic coupling constant B_{eff} is the sum of the bulk magnetoelastic coupling term (simply bulk term or volume term) and the surface magnetoelastic coupling term (simply surface term), as represented by the following equation:

$${B}_{eff} = {B}_{bulk} + \frac{{B}_{Surf}}{1} \qquad ( 2 )$$

In the equation, B_{Bulk} is the bulk magnetoelastic coupling constant, B_{Surf} is the surface magnetoelastic coupling constant, and t is the film thickness.

Subsequently, fitting was carried out for each of the compositions, the measured saturation magnetizations Mₛ of which are shown in FIG. 2, to obtain B_{Bulk} and B_{Surf} for each composition. The results obtained are plotted in FIG. 9.

The B_{Bulk} and B_{Surf} were linearly approximated for the Ni content according to the following equations, respectively:

$$\begin{matrix}{B}_{Bulk} = {B}_{1}^{Bulk} + {B}_{2}^{Bulk} \cdot {x}_{N1} & ( 3 ) \\ {B}_{Surf} = {B}_{1}^{Surf} + {B}_{2}^{Surf} \cdot {x}_{Ni} & ( 4 )\end{matrix}$$

and these were substituted for equation (2) to obtain the following equation:

$${B}_{eff} = {B}_{1}^{Bulk} + {B}_{2}^{Bulk} \cdot {x}_{Ni} + \frac{{B}_{1}^{Surf} + {B}_{2}^{Surf} \cdot {X}_{ni}}{t} \qquad ( 5 )$$

In this equation, B^{Bulk}₁, B^{Bulk}₂, B^{Surf}₁, and B^{Surf}₂ are respectively the following constants:

$${B}_{1}^{Bulk} = - 53.78 J / {cm}^{3} , \\ {B}_{2}^{Bulk} = 0.6638 J / {cm}^{3} , \\ {B}_{1}^{Surf} = 1.7548 \times {10}^{- 6} J / {cm}^{2} , and$$

$${B}_{2}^{Surf} = - 2.432 \times {10}^{- 8} J / {cm}^{2} ,$$

x_{N1} is the Ni content in wt %, and t is the filk thickness in nanometer.

The following equation was then obtained by solving the above equation (5) for B_{eff}=0:

$${x}_{Ni} = - \frac{{B}_{1}^{Surf} + {B}_{1}^{Bulk} \cdot t}{{B}_{2}^{Surf} + {B}_{2}^{Bulk} \cdot t} \qquad ( 6 )$$

From the above, it is understood that, with respect to a thin Ni—Fe film as used as a free layer in a spin valve film, the Ni content, x_{N1}, of the Ni—Fe film must satisfy the following relationship in order that the value of magnetristriction is zero or negative.

$${x}_{N1} ≧ - \frac{{B}_{1}^{Surf} + {B}_{1}^{Bulk} \cdot t}{{B}_{2}^{Surf} + {B}_{2}^{Bulk} \cdot t} \qquad ( 7 )$$

Although it has been previously known that the magnetoelastic coupling constant of a bulk material depends on the composition of the material, the dependence of the surface magnetoelastic coupling constant on the film composition has not been determined. The above equation (7) obtained by the inventors allows the effect of the surface term in an Ni—Fe film, which is increased by making the film thickness smaller, to be canceled at any Ni—Fe film thickness of less than 10 nanometers by appropriately changing the composition of the Ni—Fe material to shift the bulk term.

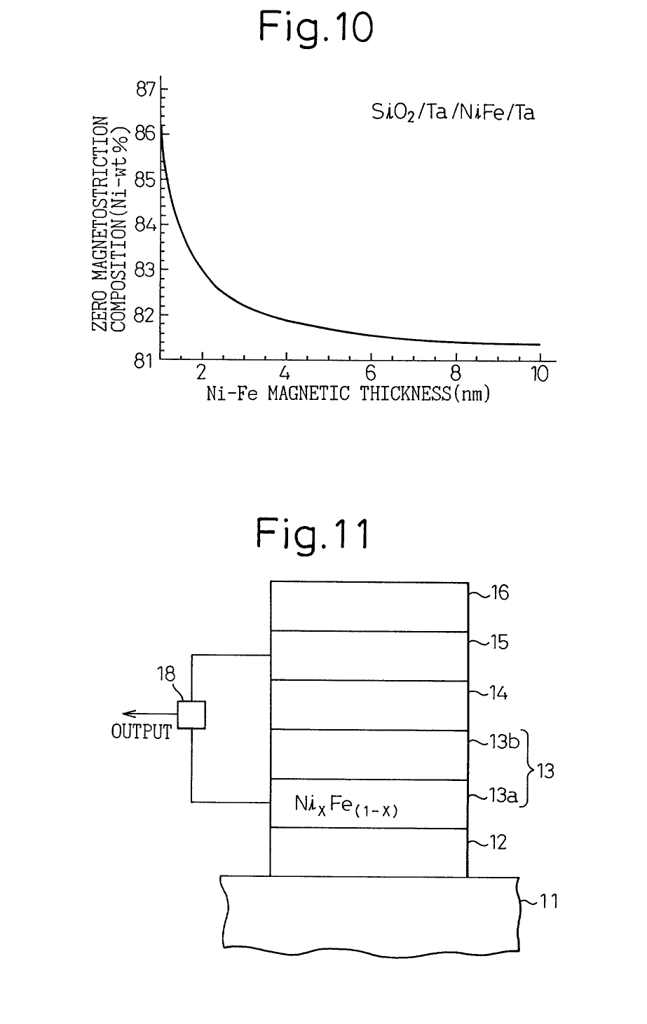

Assuming that the magnetoelastic coupling constants linearly depend on the composition, which is quite reasonable as seen in FIG. 9, the composition of the Ni—Fe material at which the magnetostriction value is zero or negative can be calculated as a function of film thickness according to equation (7). FIG. 10 shows the relation between the Ni—Fe film composition at which the magnetostriction is zero and the film thickness, and Table 1 shows that relationship together with corresponding values of magnetostriction constant λₛ. For instance, the use of a material of Ni₈₅Fe₁₅ composition, which contains about 85% by weight of Ni, reduces the effective magnetostriction of the Ni—Fe film grown in the range of magnetic thickness of 0.6 to 1.9 nanometers on a Ta underlayer when compared to the film of Ni₈₁Fe₁₉ which is used in conventional spin valve films.

TABLE 1

| | | | | | | | |
|---|---|---|---|---|---|---|---|
| NiFe magnetic | 0.65 ± 0.05 | 0.75 ± 0.05 | 0.85 ± 0.05 | 0.95 ± 0.05 | 1.05 ± 0.05 | 1.15 ± 0.05 | 1.2 ± 0.05 |
| thickness (nm) | | | | | | | |
| Ni content | 92.5 ± 2.0 | 89.5 ± 1.2 | 87.7 ± 1.0 | 86.6 ± 1.0 | 85.8 ± 1.0 | 85.5 ± 1.0 | 85.0 ± 0.5 |
| (wt %) | | | | | | | |
| λₛ (10⁻⁶) | +2.3-−2.3 | +1.5-−1.5 | +1.2-−1.2 | +1.2-−1.2 | +1.1-−1.1 | +1.0-−1.0 | +1.0-−1.0 |

Thus, by the use of a magnetic sensor having a free layer in its spin valve film, the free layer being formed of an Ni—Fe material selected so as to impart, depending on the thickness of the free layer, zero or negative magnetostriction to the layer according to the invention, it is feasible to produce a head for a magnetic storage particularly suited for high data density. In general, the magnetic sensor includes a laminate comprising a first magnetic layer (free magnetic layer) of soft ferromagnetic material, a nonmagnetic layer, a second magnetic layer (fixed magnetic layer) of ferromagnetic material, and an antiferromagnetic layer, and a converting element for detecting the change in external magnetic field and outputing it as the change in resistance, with at least part of the first magnetic layer being formed of an Ni—Fe material, and the content of Ni, x_{N1}, and the thickness, t, thereof satisfying the relationship represented by the above equation (7). The sensor is schematically shown in FIG. 11, in which the first magnetic layer of the laminate is indicated by 13 and may comprise a different magnetic layer 13b other than the Ni—Fe layer 13a as illustrated in the drawing. Also in FIG. 11, the nonmagnetic layer, the second magnetic layer, and the antiferromagnetic layer are indicated by 14, 15, and 16, respectively. Under the laminate (specifically between the laminate and a substrate 11), an underlying layer 12 formed of Ta or the like may be included and, on the antiferromagnetic layer 16, a protective layer (not shown) may be located. In addition, the first and second magnetic layers 13 and 15 are connected to a converting element 18, which detects the change in external magnetic field sensed by the sensor as the change in resistance which is, in general, further converted to the change in voltage to be output. Such a configuration itself of a magnetic sensor is well known, and is not further explained in detail herein.

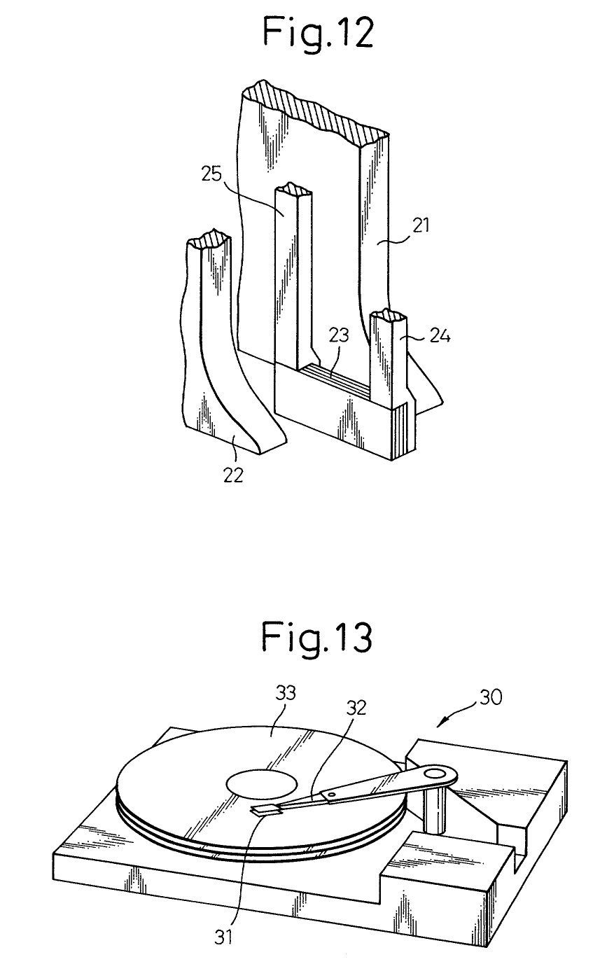

A magnetic head (read head) using the magnetic sensor of the invention is schematically shown in FIG. 12. The magnetic head of this drawing comprises a spin valve film 23 located midway between two shields 21 and 22, the spin valve film 23 having the laminated structure as described making reference to FIG. 11. Electrodes 24, 25 are connected, at one end, to the spin valve film 23, as illustrated in FIG. 12, and are also connected, at another end, to the converting element 18 as shown in FIG. 11. Such a configuration itself, as well as the operation of a magnetic head, is also well known, and is not further explained in detail herein.

FIG. 13 illustrates a hard disk device 30 as an example of the magnetic storage which utilizes a magnetic head using the magnetic sensor of the invention. The hard disk device 30 comprises a slider 32 provided at its end with a magnetic head 31, and a magnetic recording medium 33, with the slider 32 and the magnetic recording medium 33 being respectively driven by drivers not shown in the drawing. The hard disk device 30 is typically contained in a housing also not shown in the drawing. The use of the magnetic sensor of the invention as the head allows the hard disk device 30 to read high density data. Such a configuration as well as operation of a magnetic storage is also well known, and is not further explained in detail herein.

The invention will now be specifically described making reference to an example, but it is not intended that the invention is limited by the example.

On an Al₂O₃-TiC substrate provided with an SiO₂ film, a Ta layer as an underlayer was formed to have a thickness of 5 nanometers and, subsequently, a free soft magnetic layer consisting of 2.5 nanometers of Ni₈₅Fe₁₅ (figures representing weight percentages of the elements) and 2 nanometers of Co₉₀Fe₁₀ (figures representing atomic percentages of the elements), an intermediate layer of Cu having a thickness of 2.8 nanometers, a pinned soft magnetic layer of Co₉₀Fe₁₀ (figures representing atomic percentages) having a thickness of 2.2 nanometers, an antiferromagnetic layer of Pd₃₁Pt₁₇Mn₅₂ (figures representing atomic percentages) having a thickness of 15 nanometers, and a protective layer of Ta having a thickness of 5 nanometers were successively formed to make a spin valve magnetoresistive sensor, using a DC magnetron sputtering apparatus.

During the film formation, a DC external magnetic field of the order of 100 Oe (8 kA/m) may be applied in the direction of substrate plane in which the direction of magnetization of the free soft magnetic layer is parallel to the direction of a sensing current in the spin valve magnetoresistive sensor.

After the film formation, heat treatment was carried out in a vacuum of not greater than 1×10⁻⁶ Pa and at 280° C. for about 3 hours while applying a DC external magnetic field of 2.5 kOe (200 kA/m) in the direction of the substrate plane perpendicular to the direction of external magnetic field applied during the film formation in order to fix the direction of the pinned soft magnetic layer to the direction perpendicular to that of sensing current in the spin valve magnetoresistive sensor.

After the heat treatment, the layers were patterned to have a given shape of sensing element by conventional photolithography and ion milling processes and, subsequently, hard bias films and electrode films were successively formed at both ends of the element by a lift-off process. The hard bias film can be formed of, in general, a Co—Cr—Pt or Co—Pt alloy, and has a thickness of about 20 nanometers. The electrode film is formed of, in general, Au, and has a thickness of about 60 nanometers.

After the formation of the element, the hard bias films at both ends were magnetized by applying a DC magnetic field of 3 kOe (240 kA/m) at room temperature in the longitudinal direction (which was parallel to the direction of the sensing current in the sensing element). Measurement of magnetoresistive properties of the spin valve magnetoresistive sensor thus obtained in an external sweep magnetic field of ±500 Oe (40 kA/m) revealed a rate of occurrence of Barkhausen noise of 5% or smaller.

For comparison, samples which were similarly made except for having a free magnetic layer consisting of 2.5 nanometers thick Ni₈₁Fe₁₉ (figures representing weight percentages of the elements) and 2 nanometers thick Co₉₀Fe₁₀ (figures representing atomic percentages of the elements) revealed a rate of occurrence of Barkhausen noise of 50 to 100.

Generally speaking, as the thickness of a free layer is reduced in spin valve read sensors with increasing recording density, the magnetostriction of conventional Ni₈₁Fe₁₉ free layers will be large and positive (of the order of +10⁻⁶ to +10⁻⁵), which will cause domain instability and increasing Barkhausen noise in read heads. The invention allows a free layer of Ni—Fe having a composition to provide zero or negative magnetostriction at any thickness between 0.6 to 10 nanometers to be utilized.

Although the invention has been described by mainly referring to a top-type spin valve film, it is possible to apply the invention to a bottom-type spin valve film. It is also possible to commonly apply the invention to magnetoresistive effect elements using a laminated structure comprising a layer of Ni—Fe material.

In addition, the invention is also applicable to tunnel junction elements also using a laminated structure comprising a layer of Ni—Fe material.

The invention makes it possible to provide magnetic sensors with a free magnetic layer having a zero or negative magnetostriction and magnetic storage using the sensor, to thereby makes it possible to use magnetic storages having an increased recording density.

1. A magnetic sensor which includes a laminate comprising a first magnetic layer of soft ferromagnetic material, a nonmagnetic layer, a second magnetic layer of ferromagnetic material, and an antiferromagnetic layer, and a converting element for detecting the change in external magnetic field as the change in resistance and outputing it, with at least part of the first magnetic layer being formed of an Ni—Fe material, and the content of Ni, x_{N1}, in wt % and the thickness, t, in nanometers thereof satisfying the relation represented by the following equation:
$${x}_{N1} ≧ - \frac{{B}_{1}^{Surf} + {B}_{1}^{Bulk} \cdot t}{{B}_{2}^{Surf} + {B}_{2}^{Bulk} \cdot t}$$
wherein
$$\begin{matrix}{B}_{1}^{Bulk} & = & - 53.78 J \text{/} {cm}^{3} , \\ {B}_{2}^{Bulk} & = & 0.6638 J \text{/} {cm}^{3} , \\ {B}_{1}^{Surf} & = & 1.7548 \times {10}^{- 6} J \text{/} {cm}^{2} , and \\ {B}_{2}^{Surf} & = & - 2.432 \times {10}^{- 8} J \text{/} {cm}^{2} .\end{matrix}$$

2. The magnetic sensor of claim 1, wherein the first magnetic layer consists of the Ni—Fe material.

3. The magnetic sensor of claim 1, wherein the first magnetic layer comprises a sublayer of the Ni—Fe material and at least a sublayer of magnetic material other than the Ni—Fe material.

4. The magnetic sensor of claim 1, wherein the first magnetic layer has a thickness of less than 10 nanometers.

5. The magnetic sensor of claim 1, wherein the nonmagnetic layer is formed of copper.

6. The magnetic sensor of claim 1, wherein the second magnetic layer is formed of a material selected from the group consisting of cobalt or a Co—Fe alloy.

7. The magnetic sensor of claim 1, wherein the antiferromagnetic layer is formed of a material selected from the group consisting of Pt—Mn, Ni—Mn, and Fe—Mn alloys, NiO, and Fe₂O₃.

8. The magnetic sensor of claim 1, wherein the laminate is located on a substrate.

9. The magnetic sensor of claim 8, wherein an underlayer is interposed between the laminate and the substrate.

10. The magnetic sensor of claim 9, wherein the underlayer is formed of tantalum and has a thickness of 1 to 10 nanometers.

11. The magnetic sensor of claim 8, wherein the set of first and second magnetic layers is located between the antiferromagnetic layer and the substrate.

12. The magnetic sensor of claim 8, wherein the antiferromagnetic layer is located between the set of first and second magnetic layers and the substrate.

13. The magnetic sensor of claim 8, wherein a protective layer is provided on the laminate.

14. A magnetic storage comprising a magnetic head and a magnetic recording medium, wherein the magnetic head comprises a magnetic sensor which includes a laminate comprising a first magnetic layer of soft ferromagnetic material, a nonmagnetic layer, a second magnetic layer of ferromagnetic material, and an antiferromagnetic layer, and a converting element for detecting the change in external magnetic field as the change in resistance and outputing it, with at least part of the first magnetic layer being formed of an Ni—Fe material, and the content of Ni, x_{Ni}, in wt % and the thickness, t, in nanometer thereof satisfying the relation represented by the following equation:
$${x}_{Ni} ≧ - \frac{{B}_{1}^{Surf} + {B}_{1}^{Bulk} \cdot t}{{B}_{2}^{Surf} + {B}_{2}^{Bulk} \cdot t}$$
wherein
$$\begin{matrix}{B}_{1}^{Bulk} & = & - 53.78 J \text{/} {cm}^{3} , \\ {B}_{2}^{Bulk} & = & 0.6638 J \text{/} {cm}^{3} , \\ {B}_{1}^{Surf} & = & 1.7548 \times {10}^{- 6} J \text{/} {cm}^{2} , and \\ {B}_{2}^{Surf} & = & - 2.432 \times {10}^{- 8} J \text{/} {cm}^{2} .\end{matrix}$$

15. The magnetic storage of claim 14, wherein the first magnetic layer consists of the Ni—Fe material.

16. The magnetic storage of claim 14, wherein the first magnetic layer comprises a sublayer of the Ni—Fe material and at least a sublayer of magnetic material other than the Ni—Fe material.

17. The magnetic storage of claim 14, wherein the first magnetic layer has a thickness of less than 10 nanometers.

18. The magnetic storage of claim 14, wherein the nonmagnetic layer is formed of copper.

19. The magnetic storage of claim 14, wherein the second magnetic layer is formed of a material selected from the group consisting of cobalt or a Co—Fe alloy.

20. The magnetic storage of claim 14, wherein the antiferromagnetic layer is formed of a material selected from the group consisting of Pt—Mn, Ni—Mn, and Fe—Mn alloys, NiO, and Fe₂O₃.

21. The magnetic storage of claim 14, wherein the laminate is located on a substrate.

22. The magnetic storage of claim 21, wherein an underlayer is interposed between the laminate and the substrate.

23. The magnetic storage of claim 22, wherein the underlayer is formed of tantalum and has a thickness of 1 to 10 nanometers.

24. The magnetic storage of claim 21, wherein the set of first and second magnetic layers is located between the antiferromagnetic layer and the substrate.

25. The magnetic storage of claim 21, wherein the antiferromagnetic layer is located between the set of first and second magnetic layers and the substrate.

26. The magnetic storage of claim 21, wherein a protective layer is provided on the laminate.
